(19) United States
(12) Patent Application Publication
(10) Pub. No.: US 2026/0212500 A1
(43) Pub. Date: Jul. 23, 2026

(54) AUTOMATED SYSTEMS AND METHODS FOR CHEMICAL IDENTIFICATION FROM DRIED DROPLET IMAGES

(71) Applicant: The Florida State University Research Foundation, Inc., Tallahassee, FL (US)

(72) Inventors: Oliver Steinbock, Tallahassee, FL (US); Bruno C. Batista, Tallahassee, FL (US)

(21) Appl. No.: 19/453,126

(22) Filed: Jan. 20, 2026

Related U.S. Application Data
(60) Provisional application No. 63/747,568, filed on Jan. 21, 2025.

(51) Int. Cl. G06T 7/00; G06T 7/11; G06T 7/13; G06T 7/143; G06T 7/44

(52) U.S. Cl. CPC G06T 7/0012; G06T 7/11; G06T 7/13; G06T 7/143; G06T 7/44; G06T 2207/20081; G06T 2207/20084

(57) ABSTRACT

In one embodiment, a system for determining the concentration and composition of dried droplets is provided. The system includes a robotic drop imager that generates a plurality of dried droplet samples for a variety of chemical compositions at a variety of concentrations. The robotic drop imager allows for samples to be quickly generated with a standard droplet size. After each sample has dried, the robotic drop imager generates one or more images of each sample, which are then labeled based on the known composition and concentration. Each labeled image is further processed into a plurality of metrics that capture structural and textural features of the image. The labeled images, including metrics, are then used to train an artificial intelligence model.

### CROSS-REFERENCE TO RELATED APPLICATIONS

This application claims priority to U.S. Provisional Patent No. 63/747,568, filed on Jan. 21, 2025, entitled “HIGH-THROUGHPUT ROBOTIC COLLECTION, IMAGING, AND MACHINE LEARNING ANALYSIS OF SALT PATTERNS: COMPOSITION AND CONCENTRATION FROM DRIED DROPLET PHOTOS.” The contents of which are hereby incorporated by reference.

### STATEMENT REGARDING FEDERALLY SPONSORED RESEARCH OR DEVELOPMENT

This invention was made with government support under grant number 80NSSC23M0050 awarded by NASA. The government has certain rights in the invention.

### BACKGROUND

Microscopic chemical processes can drive profound transformations in the macroscopic world that manifest as unexpected dynamics and complex patterns. However, chemistry's ability to provoke and program such events remains largely unexplored and even modern biological research has deemphasized morphogenetic studies in favor of molecular and machine-like descriptions. This knowledge gap is in stark contrast to the intellectual and technological potential of this causal micro-to-macro chain that for living systems orchestrates cells and organisms from molecular events. The advent of laboratory automation and machine learning/artificial intelligence techniques, however, provides powerful tools to study these intriguing connections.

Two essential components of such length scale and complexity escalation are far from equilibrium conditions and transport processes such as diffusion, fluid flow, and active motion. The far from equilibrium thermodynamic state does not necessarily require the continuous supply of reactants or energy, but can often be reached as a long-lived transient along the system's path toward equilibrium. The latter transport modes promote mixing and spatial homogenization but in conjunction with nonlinear processes can create steep gradients and patterns. This counterintuitive effect is evident in the Turing instability and impacts crystal growth and other solidification events, such as periodic Liesegang bands, fingering instabilities during directional melt solidification, and dendritic electrodeposition.

Another process that at first glance appears exceedingly simple, is the drying of solution and dispersion drops on nonporous, horizontal surfaces. However, certain salts such as NH₄Cl induce salt creep during the drying of such sessile drops. Driven by evaporation, crystallization, and capillary action, this creeping phenomenon greatly increases the footprint of the drops and the resulting deposit. Another counterintuitive example is the coffee-ring effect that occurs when a drop with small suspended particles dries on a flat surface. The ring of dry particulate matter results from the pinning of the contact line and flow that transports particles to the edge of the evaporating drop. In many crystallizing solutions, the patterns formed can be complex, ranging from isolated small crystals to dendritic structures or featureless disks.

Previous studies have demonstrated that the deposit patterns formed by drying droplets might reveal compositional features of the employed solution, including tap water and alcoholic beverages. For human tears, the drying patterns have been suggested as an inexpensive diagnostic tool for conditions such as dry-eye disease, where the resulting fern-like structures are indicative of the tear's composition. Similarly, blood drops from patients with various medical conditions, including leukemia and anemia, tend to form distinctive patterns upon drying, potentially serving as diagnostic markers. In addition, mixtures of KCl or KCl/MgCl₂ solutions with urine produce drop deposits that deep neural networks can potentially analyze to diagnose bladder cancer.

### SUMMARY

In one embodiment, a system for determining the concentration and composition of dried droplets is provided. The system includes a robotic drop imager that generates a plurality of dried droplet samples for a variety of chemical compositions at a variety of concentrations. The robotic drop imager allows for samples to be quickly generated with a standard droplet size. After each sample has dried, the robotic drop imager generates one or more images of each sample, which are then labeled based on the known composition and concentration. Each labeled image is further processed into a plurality of metrics that capture structural and textural features of the image. The labeled images, including metrics, are then used to train an artificial intelligence model.

At a later time, a solution of unknown chemical composition and concentration is received by the same or different robotic drop imager. One or more dried droplet samples are generated for the solution by the robotic drop imager as described above. Images of each sample are processed into the plurality of metrics and used as an input to the trained artificial intelligence model. The model outputs a predicted composition and/or concentration for the solution.

The disclosed systems and methods provide several advantages over the prior art. For example, unlike generic machine-learning models trained directly on raw images, disclosed systems and methods use controlled droplet formation and engineered, physically interpretable metrics derived from the resulting dried patterns. This structured representation of the image data improves classification accuracy and generalization by embedding domain-specific knowledge into the learning process, thereby reducing dependence on large training datasets, mitigating overfitting to incidental visual features, and substantially reducing the amount of training data required.

In some aspects, the techniques described herein relate to a method for determining composition and concentration of unknown samples, the method including: receiving a plurality of samples by a computing device, wherein each sample has a known composition and known concentration; for each sample of the plurality of samples, generating a plurality of deposits of the sample by the computing device; for each deposit of the plurality of deposits, generating an image of the deposit by the computing device; for each generated image of a deposit, labeling the image of the deposit with the known composition and known concentration of the deposit by the computing device; and training a machine learning model with the generated images and associated labels by the computing device.

In some aspects, the techniques described herein relate to a method, wherein the computing device is part of a robotic drop imager.

In some aspects, the techniques described herein relate to a method, wherein each deposit has a controlled volume of between 1 and 50 μL.

In some aspects, the techniques described herein relate to a method, further including waiting approximately 2 hours for the deposits to dry before generating the images. The humidity and temperature of the environment containing the deposits may be controlled to speed up or slow down the drying process.

In some aspects, the techniques described herein relate to a method, further including, for each generated image of a deposit, generating a plurality of metrics from the image of the deposit, and associating the image of the deposit with the generated plurality of metrics.

In some aspects, the techniques described herein relate to a method, wherein training a machine learning model with the generated images and associated labels includes training the machine learning model with the plurality of metrics associated with each image and the labels associated with each image.

In some aspects, the techniques described herein relate to a method, wherein generating the plurality of metrics from the image of the deposit includes generating a binary image from the image, and generating the plurality of images from the binary image.

In some aspects, the techniques described herein relate to a method, wherein the plurality of metrics include one or more of deposit area, boundary length, connected bright regions, and eccentricity.

In some aspects, the techniques described herein relate to a method, the plurality of metrics further include a distribution of bright pixels from a centroid of the image.

In some aspects, the techniques described herein relate to a method, wherein the plurality of metrics further include a mean, median, mode, standard deviation, and skewness of the distribution.

In some aspects, the techniques described herein relate to a method, further including: receiving a sample with an unknown composition and unknown concentration; generate at least one deposit of the received sample; generate an image of the at least one deposit; and using the machine learning model to identify one or both of a composition and a concentration for the received sample.

In some aspects, the techniques described herein relate to a system for determining composition and concentration of unknown samples, the system including: at least one computing device; a deposit generator adapted to: receive a plurality of samples, wherein each sample has a known composition and known concentration; and for each sample of the plurality of samples, generate a plurality of deposits of the samples at precisely defined locations on a plurality of slides; an image generator adapted to: for each deposit of the plurality of deposits, generate an image of the deposit; a metric generator adapted to: for each generated image of a deposit, label the image of the deposit with the known composition and known concentration of the deposit; and a training component adapted to: train a machine learning model with the generated images and associated labels. The spacing and locations of the generated samples may be set by a user or administrator.

In some aspects, the techniques described herein relate to a system, wherein the system is a robotic drop imager.

In some aspects, the techniques described herein relate to a system, wherein each deposit has a volume of between 1 and 50 μL.

In some aspects, the techniques described herein relate to a system, wherein the image generator waits approximately 2 hours for the deposits to dry before generating the images.

In some aspects, the techniques described herein relate to a system, wherein the metric generator is further adapted to, for each generated image of a deposit, generate a plurality of metrics from the image of the deposit, and associate the image of the deposit with the generated plurality of metrics.

In some aspects, the techniques described herein relate to a system, wherein the model generator adapted to train the machine learning model with the generated images and associated labels includes the model generator adapted to train the machine learning model with the plurality of metrics associated with each image and the labels associated with each image.

In some aspects, the techniques described herein relate to a system, wherein the plurality of metrics include one or more of deposit area, boundary length, connected bright regions, and eccentricity.

In some aspects, the techniques described herein relate to a system, the plurality of metrics further include a distribution of bright pixels from a centroid of the image.

In some aspects, the techniques described herein relate to a system, wherein the system further includes a composition identifier adapted to: receive a sample with an unknown composition and unknown concentration; generate at least one deposit of the received sample; generate an image of the at least one deposit; and use the machine learning model to identify one or both of a composition and a concentration for the received sample.

### BRIEF DESCRIPTION OF THE DRAWINGS

The components in the drawings are not necessarily to scale relative to each other. Like reference numerals designate corresponding parts throughout the several views.

FIG. 1 is an illustration of an example robotic drop imager system 100;

FIG. 2 is another illustration of an example robotic drop imager system 100;

FIG. 3 are illustrations 300 of a plurality of deposits 104;

FIG. 4 is an illustration of an example method 400 for training a model to identify compositions and concentrations from images of deposits;

FIG. 5 is an illustration of an example method 500 for using a model to identify compositions and concentrations from images of deposits; and

FIG. 6 illustrates an example computing device.

### DETAILED DESCRIPTION

Previous studies have demonstrated that the deposit patterns formed by drying droplets might reveal compositional features of the employed solution, including tap water and alcoholic beverages. For human tears, the drying patterns have been suggested as an inexpensive diagnostic tool for conditions such as dry-eye disease, where the resulting fern-like structures are indicative of the tear's composition. Similarly, blood drops from patients with various medical conditions, including leukemia and anemia, tend to form distinctive patterns upon drying, potentially serving as diagnostic markers. In addition, mixtures of KCl or KCl/MgCl₂ solutions with urine produce drop deposits that deep neural networks can potentially analyze to diagnose bladder cancer.

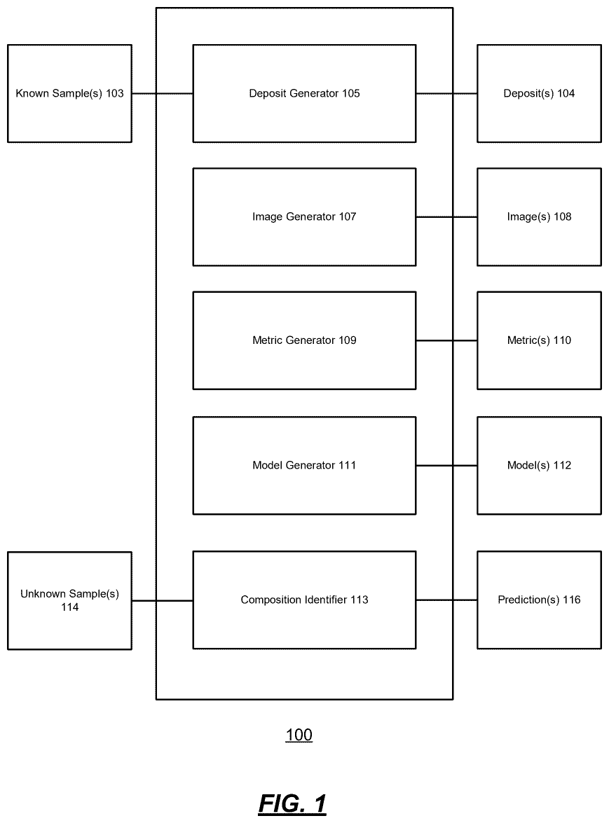

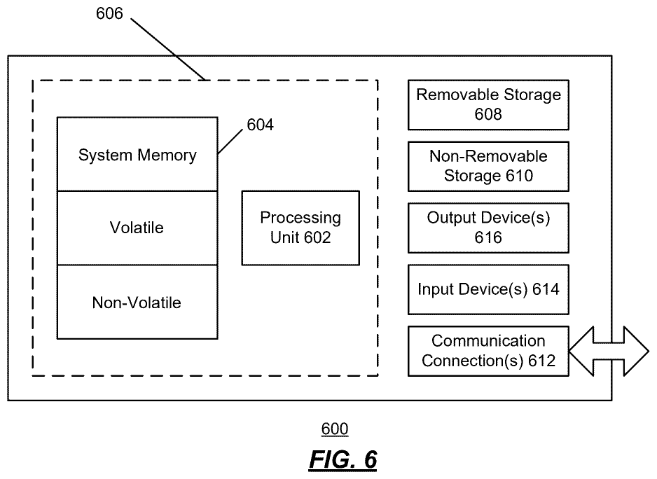

Accordingly, in order to allow for the identification of composition and concentration of certain chemicals in droplets 104, the robotic drop imager system 100 is provided. As shown in FIG. 1, the system 100 includes several components that include, but are not limited to: a deposit generator 105, an image generator 107, a metric generator 109, a model generator 111, and a composition identifier 113. More or fewer components may be supported. The system 100 and its various components may be implemented together or separately using one or more general purpose computing devices such as the computing system 600 illustrated with respect to FIG. 6. Note that the methods described herein are not limited to the robotic imager system 100. Some or all of the aspects of the described methods may be implemented manually.

The deposit generator 105 receives a plurality of known samples 103 and generates deposits 104. The known samples 103 may be samples having a known composition and a known concentration of the known composition. Example compositions include ammonium chloride (NH₄Cl); sodium chloride (NaCl); potassium chloride (KCl); sodium sulfate (Na₂SO₄); potassium nitrate (KNO₃); sodium sulfite (Na₂SO₃); sodium nitrate (NaNO₃). Example concentrations include 10%, 30%, 50%, 70%, and 90% v/v. Note that these are provided as examples only, other compositions, concentrations, compounds, and complex solutions may be supported. For example, in some embodiments, the described systems and methods may be used with complex solutions such as urine or hard water.

As will be described further below, a user or administrator may initially select the known samples 103 that will be used to train one or more models 112 that are used by the system 100 to identify one or more unknown samples 114. Accordingly, the unknown samples 103 may be selected so they include a variety of compositions at a variety of concentrations. Any method for selecting and preparing training samples may be used.

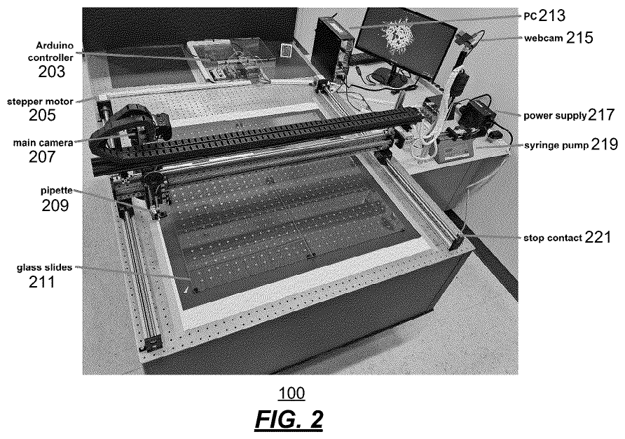

The deposit generator 105 may include a fluid delivery unit that is adapted to generate a plurality of deposits 104 from known samples 103. Depending on the embodiment, each deposit 104 may be of a uniform size and shape and may be deposited onto a slide (i.e., one of the slides 211 of FIG. 2). The deposit generator 105 may include a fluid delivery unit that is controlled by a computing device and adapted to place each deposit 104 on a corresponding slide. With reference to FIG. 2, the fluid delivery unit may include a pipette 209, a syringe pump 219, and a power supply, mounted to a two-dimensional positioning component. The two-dimensional positioning component may include a stepper motor 205 and a stop contact 221 and may be controlled by one or more both of the Arduino controller 203 and PC 213.

In some embodiments, the pipette 209 may be a disposable pipette tip with a conical shape and an approximate hold diameter of approximately 400 μm. The deposit generator 140 advances the pipette 209 to a position over a slide in the glass slides 211 using the two-dimensional positioning component. The syringe pump 219 delivers solution at a flow rate of approximately 8-12 ml/h. depending on the solution. This causes drops to form on the tip of the pipette 209 and detach at a frequency of between 12 and 16 drops per minute. The deposit generator 105 may include a photocell that detects the detachment of the drop, and in response to detecting the detachment, may cause the pipette 209 to advance to a next slide in the slides 211 or an empty position on the current slide. The slides 211 may be placed such that pipette 209 is able to be advanced to a next slide (or next empty position) in the time it takes for the droplet to form and detach from the pipette 209. Depending on the embodiment, the distance between the slides 211 and the pipette 209 is approximately 7.5 mm. Other distances may be supported.

After generating the deposits 104, the deposit generator 104 may wait a selected amount of time for the slides 211 to dry. Depending on the embodiment, the deposit generator 104 may wait two hours. Other time durations may be selected. In some embodiments, the system 100 may monitor the deposits (using a camera or other imaging component) and may determine that the slides have dried after no changes in the deposit patterns are detected. Other methods may be used. In some embodiments, the deposit generator 104 may monitor and control the temperature and humidity of the environment where the deposits 104 are drying to ensure the deposits 104 dry and form consistently. The relative humidity may be maintained below the expected salt deliquescence humidity. The temperature and humidity may be selected by a user or administrator based on the expected salt composition of the deposits 104.

After the deposits 104 have dried on slides 211, the image generator 107 may generate an image 108 from each of the generated deposits 104. In some embodiments, with reference to FIG. 2, the image generator 107 may include a main camera 207 that generates the images 108 of the slides 211 and provides the generated images for storage by the Arduino controller 203 and/or the PC 213. The main camera 207 may be attached to the same or different two-dimensional positioning component that was used to move the pipette 209. In some embodiments, the main camera 207 is a Nikon z5 using a macro lens such as the Nikkor Z MC 105 mm f/2.8. Other camera and lens combinations may be used. Depending on the embodiment, the image generator 107 may further include a webcam 215 that may allow one or more users or administrators to view the operation of the system 100 and/or the slides 211. Note that that the image generator 107 shown and described is for illustrative purposes only. Other types of imaging devices capable of capturing dried droplet morphology may be used.

In some embodiments, the camera 207 and the fluid delivery unit may be mounted to the two-dimensional positioning component along with a light source. The light source may include some number of LED lights (e.g., 50). The light source may illuminate each dried deposit 104 at a low angle from a variety of directions. However, other types of light sources may be used.

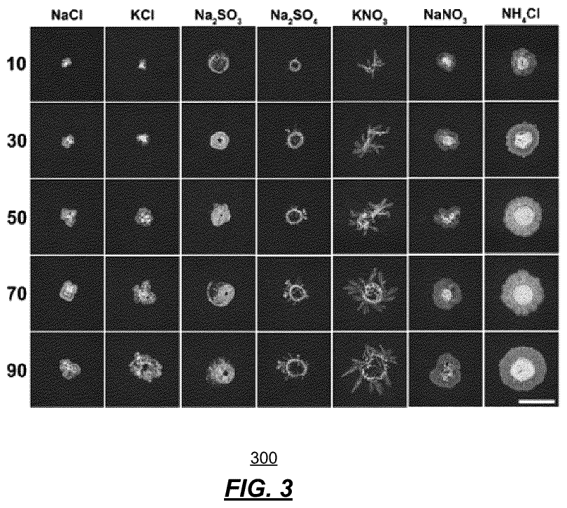

FIG. 3 is an illustration 300 of images 108 captured from the deposits 104 of the dried slides 211. In the example shown, the illustration 300 includes a plurality of columns and a plurality of rows. Each column includes images 108 corresponding to the compositions NaCl, KCl, Na₂SO₄, NKO₃, NaNO₃, and NH₄Cl. Each row includes images 108 corresponding to the to the concentrations 10%, 30%, 50%, 70%, and 90% v/v. Other compositions and concentrations may be supported. As can be seen in the illustrations 300, each composition and concentration creates unique variations and patterns that may be leveraged to identify the composition and concentration of an unknown solution.

Returning to FIG. 1, the metric generator 109, may generate a plurality of metrics 110 from each of the images 108. As will be described further below, these metrics 110 may be generated based on physical characteristics of each of the images 108 and may be used to train a model 112 to predict a composition and concentration of an unknown sample 114. As may be appreciated, each image 108 may be very large, and therefore training a model 112 using a vector of metrics 110 determined for each image 108 rather than the image 108 itself, can greatly reduce the amount of processing power needed to process each image 108, as well as the amount of storage that is needed to store each image 108.

In one embodiment, the metrics 110 generated for an image 108 may be based on the size and shape of the deposit area of each deposit 104 in an image 108. In these embodiments, the metric generator 109 may convert each image 108 to a gray-scale image. The metric generator 109 may further process the image 108 by applying a constant intensity threshold to create a binary image whose pixels can be used to distinguish the dark background of the image from the brighter regions of the associated deposit 104.

The metric generator 109 may extract one or more metrics 110 from the processed gray-scale image. In some embodiments, these metrics 110 may include the overall area of the deposit 104, the length of the deposit area or boundary length, the number of connected bright regions in the deposit 104, and an eccentricity of the deposit 104. In addition, the metric generator 109 may compute a distribution of bright pixels from a centroid of the deposit 104. From this distribution, the metric generator 109 may derive five metrics 110 including the mean, median, mode, standard deviation, and skewness. Additional metrics 110 include metrics 110 related to image erosional behavior, and metrics 110 related to dark pixel regions embedded in bright pixel regions of the image 108.

In some embodiments, the metrics 108 computed by the metric generator 109 may be grouped into the following categories: edge characteristics, statistical analyses, spatial distribution, radial variations, structural complexity, textural analysis, and detailed textural variations. These categories are discussed in more detail below.

Edge characteristics: These metrics 110 relate to the density of edge points at both low and high thresholds in the image 108, which provide insights into the boundary's jaggedness or smoothness. Comparisons between the total area of the deposit 104 in the image 108 and the number of edge points further elucidate the boundary's complexity relative to the overall size of the deposit 104.

Statistical analyses: Here the uniformity or heterogeneity within the deposit 104 in the image 108 is explored by evaluating the standard deviation of pixel intensities across different thresholds. This analysis may be complemented by metrics 110 that focus on the shapes and sizes of the more distinct, brighter regions. These metrics 110 provide median values for the eccentricity and area of these regions, highlighting typical dimensions and elongation.

Spatial distribution: Metrics 110 assessing the concentration and brightness of the image 108 within a central defined area shed light on the core density and luminance of the deposit 104. Additionally, the proportion of darker areas within this zone highlights the internal contrast and composition of the frequently encountered core.

Radial variations: The distribution's ‘tailedness’ and asymmetry of intensity distributions, alongside comparisons of average intensities between different sections, are captured by these metrics 110. This provides a detailed view of radial intensity variations throughout the deposit 104 of the image 108.

Structural complexity: The relationships between the skeletonization of a deposit 104 and its area are computed to assess connectivity, branching, and terminal structures. The structural complexity metrics 110 include estimates of the fractal dimension of the deposit 104 to quantify its structural complexity.

Textural analysis: These metrics 110 include entropy measures that quantify the randomness and complexity of textures at multiple scales. Intensity variations along radial directions reveal differences in boundary distances and the structural highlights near the center. Moreover, texture consistency and uniformity are analyzed using correlation and energy metrics from the gray-level co-occurrence matrix, which explore the spatial dependencies of pixel intensities.

Detailed textural variations: A comprehensive examination of textural variations across different scales is performed by the metric generator 109, along with a quantification of the complexity of distinct regions within the deposit at high thresholds. This reveals the diversity and intricacy of the textural features of the deposit 104, providing a deeper understanding of its unique characteristics.

A listing of example metrics 110 is described in more detail in the table below. More or fewer metrics 110 may be generated by the metric generator 109 for each image 108 generated by the image generator 107. Note that these metrics 110 are examples only and not meant to be an exhaustive list of possible metrics. Other metrics 110 may be used.

| | |
|---|---|
| numWhitePixels | This metric 110 is the total |
| | count of white pixels in the |
| | image 108. It specifies the total |
| | deposit area in the image 108. |
| numBlackPixels | This metric 110 is the total |
| | count of black pixels within |
| | regions surrounded by white |
| | pixels in the image 108. This |
| | metric 110 is sensitive to small |
| | gaps in the white regions that |
| | connect the black region to the |
| | global background in the image |
| | 108. If such a gap exists, the |
| | black area may not be analyzed |
| | by the metric generator 109. |
| ratio | This metric 110 is the ratio of |
| | the pixel counts in the |
| | previous two metrics 110, |
| numLargeBlobs | This metric 110 is the total |
| | number of connected white |
| | areas in the image 108. |
| perimeterLength | This metric 110 is the sum of |
| | the perimeter lengths of all |
| | connected white areas in the |
| | image 108. For a given total |
| | white area, it increases with |
| | numLargeBlobs and the |
| | eccentricity of the individual |
| | blobs. |
| axisRatio | This metric 110 is the |
| | eccentricity as calculated from |
| | the best-fit ellipse for all white |
| | pixels. Values larger than one |
| | indicate that the deposit |
| | deviates from a circular disk. |
| countLargeHoles | This metric 110 is the number of |
| | black connected areas (holes) |
| | larger than a threshold of 1000 |
| | pixels. Other thresholds may be |
| | used. |
| medianLargeHoleAreas | This metric 110 is the median |
| | value of the black connected |
| | areas (holes) larger than a |
| | threshold of 1000 pixels. Other |
| | thresholds may be used. |
| maxLargeHoleAreas | This metric 110 is the maximum |
| | value of the black connected |
| | areas (holes) larger than a |
| | threshold of 1000 pixels. Other |
| | thresholds may be used. |
| meanDistances | This metric 110 is the average of |
| | the distances of all white pixels |
| | from their common centroid. |
| stdDistances | This metric 110 is the standard |
| | deviation of the distances of all |
| | white pixels from their common |
| | centroid. |
| modeDistances | This metric 110 is the most |
| | frequent value among the |
| | distances of all white pixels from |
| | their common centroid. |
| medianDistances | This metric 110 is the median of |
| | the distances of all white pixels |
| | from their common centroid. |
| skewnessDistances | This metric 110 is the degree of |
| | asymmetry observed in the |
| | distribution of the distances of |
| | all white pixels from their |
| | common centroid. Zero implies |
| | a symmetric distribution, |
| | whereas positive ( or negative) |
| | values indicate that the |
| | distribution is skewed to the |
| | right (or left). |
| erosionslope | This metric 110 is computed by |
| | the metric generator 111 as the |
| | fraction of the remaining white |
| | pixels f in the image 108 after |
| | erosion with disks of radiusr. |
| | The slope of f(r) for small disk |
| | radii (0-4 pixels) defines this |
| | measure. Large values indicate |
| | the presence of fine details in |
| | the deposit pattern. |
| frct01 | This metric 110 is computed by |
| | the metric generator 109 as the |
| | fraction of the remaining white |
| | pixels f after erosion with disks |
| | of radius r. The smallest disk |
| | radius for which f(r) ≤ 0.1 |
| | defines this integer measure. |
| | Large values indicate compact |
| | deposit patterns such as |
| | featureless white disks, |
| medianEccentricity | This metric 110 represents the |
| | median eccentricity of |
| | connected regions above the |
| | high threshold. Eccentricity |
| | measures how elongated a |
| | shape is, with values closer to 1 |
| | indicating more elongated |
| | shapes. |
| medianArea | This metric 110 measures the |
| | median area of connected |
| | regions above the high |
| | threshold. This represents the |
| | typical size of the bright |
| | precipitate regions. |
| sumEdgesLow | This metric 110 measures the |
| | ratio of the edge points |
| | detected in the low-threshold |
| | binary image to the precipitate |
| | area. It provides a measure of |
| | edge density, indicating how |
| | jagged or smooth the |
| | precipitate boundary is in less |
| | intense regions. |
| sumEdgesHigh | This metric 110 measures the |
| | ratio of the edge points |
| | detected in the high-threshold |
| | binary image to the precipitate |
| | area. This metric 110 focuses |
| | on the density of edges in the |
| | brighter, more intense regions |
| | of the precipitate, |
| areaOverEdgeLow | This metric 110 measures a |
| | ratio of the total precipitate |
| | area to the number of edge |
| | points in the low-threshold |
| | image 108. A higher value |
| | suggests larger, more |
| | contiguous precipitate regions |
| | relative to their boundary |
| | length. |
| areaOverEdgeHigh | This metric 110 measures a |
| | ratio of the total precipitate |
| | area to the number of edge |
| | points in the high-threshold |
| | image 108. This metric 110 |
| | assesses the relationship |
| | between the area of brighter |
| | regions and their boundary |
| | complexity. |
| stdRaw | This metric 110 measures a |
| | standard deviation of pixel |
| | intensities above the low |
| | threshold in the image 108. It |
| | quantifies the variability in |
| | intensity within the precipitate, |
| | indicating how uniform or |
| | heterogeneous the precipitate |
| | is. |
| areaHigh | This metric 110 measures a |
| | total number of pixels above |
| | the high threshold, |
| | representing the area of the |
| | more intense, bright precipitate |
| | regions. |
| stdHigh | This metric 110 measures a |
| | standard deviation of pixel |
| | intensities above the high |
| | threshold. This measures the |
| | intensity variability within the |
| | bright regions of the |
| | precipitate. |
| compactnessCenter | This metric 110 measures a |
| | fraction of pixels above the low |
| | threshold within a defined |
| | central disk (radius radiCenter = |
| | 200 pixels) around the centroid. |
| | This indicates how densely |
| | packed the precipitate is in the |
| | core region. |
| brightnessCenter | This metric 110 captures the |
| | average brightness of pixels |
| | within the central disk (radius |
| | radiCenter = 200 pixels) around |
| | the centroid. This metric 110 |
| | provides an overall measure of |
| | the intensity in the core region. |
| blackCoreFraction | This metric 110 measures the |
| | fraction of pixels below the low |
| | threshold within the central |
| | disk, indicating the proportion |
| | of dark areas in the core region |
| | relative to the total core area. |
| intensityKurtosis | This metric 110 captures the |
| | kurtosis of pixel intensities |
| | above the low threshold. |
| | Kurtosis measures the |
| | “tailedness” of the intensity |
| | distribution, with higher values |
| | indicating more pronounced |
| | peaks. |
| intensitySkewness | This metric 110 captures the |
| | skewness of pixel intensities |
| | above the low threshold. |
| | Skewness measures the |
| | asymmetry of the intensity |
| | distribution, with positive |
| | values indicating a right-skewed |
| | distribution and negative values |
| | indicating a left-skewed |
| | distribution. |
| intensityRatio | This metric 110 measures a |
| | ratio of average intensities |
| | between inner and outer ring- |
| | sections of the precipitate. This |
| | metric 110 assesses radial |
| | intensity variation from the |
| | center outwards. |
| skeletonLength | This metric 110 measures a |
| | ratio of the length of the |
| | skeletonized precipitate (a |
| | representation of its structure) |
| | to the precipitate area. This |
| | indicates structural complexity |
| | and connectivity within the |
| | precipitate. |
| skeletonBranchPoints | This metric 110 measures a |
| | ratio of skeleton branch points |
| | (junctions in the skeleton) to the |
| | precipitate area, indicating the |
| | complexity and branching |
| | nature of the structure. |
| skeletonEndPoints | This metric 110 measures a |
| | ratio of skeleton endpoints to |
| | the precipitate area, providing a |
| | measure of the number of |
| | terminal points in the skeleton. |
| fractalDim | This metric 110 is an estimate |
| | of the fractal dimension, |
| | representing the complexity |
| | and self-similarity of the |
| | precipitate structure in the |
| | image 108. Higher values |
| | indicate more complex, self- |
| | similar structures. |
| log10Entropy | This metric 110 measures the |
| | log-transformed entropy of the |
| | image normalized by the |
| | precipitate area. Entropy |
| | measures the randomness of |
| | pixel intensities, with higher |
| | values indicating more complex |
| | textures. |
| waveletEntropy | This metric 110 measures an |
| | entropy of wavelet coefficients |
| | normalized by the precipitate |
| | area, representing the |
| | complexity and variability of |
| | textures at different scales. |
| stdRays | This metric 110 measures the |
| | standard deviation of average |
| | intensities along radial |
| | directions from the center. This |
| | measures how much the |
| | intensity varies as you move |
| | outwards in different directions. |
| lowRays | This metric 110 measures the |
| | median intensity of the darkest |
| | 10% of radial lines extending |
| | from the center of the |
| | precipitate outward. This |
| | metric 110 evaluates the |
| | average pixel intensity along |
| | each radial line and focuses on |
| | the dimmest regions to capture |
| | variations in brightness across |
| | different directions. This metric |
| | 110 helps quantify the spread |
| | of low-intensity areas within |
| | the precipitate, providing |
| | insights into uneven material or |
| | light distribution, |
| stdMaxRays | This metric 110 measures a |
| | standard deviation of the largest |
| | radii found along different |
| | angles from the center, |
| | indicating the variation in the |
| | boundary distance from the |
| | center. |
| corrGLCM | This metric 110 measures a |
| | correlation from the Gray-Level |
| | Co-Occurrence Matrix (GLCM), |
| | which measures the |
| | relationship between pixel |
| | intensities and their spatial |
| | dependencies, Indicating |
| | texture consistency. |
| energyGLCM | This metric 110 measures an |
| | energy from the GLCM, which |
| | quantifies the uniformity of |
| | textures. Higher values indicate |
| | more homogeneous textures. |
| meanStd5 | This metric 110 measures an |
| | average local standard |
| | deviation (calculated with a disk |
| | radius of 5 pixels) normalized by |
| | the precipitate area, indicating |
| | small-scale textural variation. |
| meanStd25 | This metric 110 measures an |
| | average local standard deviation |
| | (calculated with a disk radius of |
| | 25 pixels) normalized by the |
| | precipitate area, indicating |
| | medium-scale textural |
| | variation. |
| ms25over5 | This metric 110 measures a |
| | ratio of medium-scale to small- |
| | scale local standard deviations, |
| | providing insight into the |
| | relative textural variation at |
| | different scales. |
| ms100over25 | This metric 110 measures a |
| | ratio of large-scale (disk radius |
| | of 100 pixels) to medium-scale |
| | local standard deviations, |
| | further indicating textural |
| | variation at different levels. |
| | Other radius sizes may be |
| | selected |
| numContours | The metric 110 measures a ratio |
| | of the number of contours |
| | detected in the high-threshold |
| | image to the precipitate area, |
| | indicating the complexity and |
| | number of distinct regions |
| | within the precipitate. |

Returning to FIG. 1, the model generator 111 may train one or more models using the metrics 110 generated for each image 108 of a known sample 103. The model generator 111 may generate a model 112 by first generating training data based on the known samples 103. In some embodiments, the model generator 111 may generate training data comprising, for each image 108 of a known sample 103, generating a tuple comprising the metrics 110 extracted from the image 108 along with the known concentration and composition of each sample. In addition, dependent on the embodiment, some or all of the images 108 may be included in the tuple of training data. Any method for generating labeled training data may be used. Note that in some embodiments, the images 108, rather than the metrics 110, may be used to generate the training data.

The model generator 111 may use the generated training data to train one or more models 112 to identify the concentration and composition of one or more unknown samples. In some embodiments, each model 112 may be trained using machine learning to receive an image 108 of an unknown sample 114 (or a set of metrics 110 extracted therefrom), and to output a prediction 116. The prediction 116 may include an identification or guess as to the composition and/or concentration of the unknown sample 114. The prediction 116 may also include confidence values for the composition and/or concentration values.

In some embodiments, the model 112 may be generated using a variety of machine learning techniques including, but not limited to, Random Forest, XGBoost, and Multilayer Perceptron (MLP). Other machine learning techniques may be used.

Where the model 112 was an MLP model, the architecture of the model 112 may include an input layer followed by a plurality of connected layers. The fully connected layers may include layers with 1024, 512, 256, and 128 neurons respectively. Other sized connected layers may be used.

In addition, each of the fully connected layers may be followed by batch normalization, ReLU activation, and a dropout layer of 50%. The use of the dropout layer may prevent overfitting.

Finaly, the MLP model 112 may further include a final output layer followed by a softmax layer to generate the prediction 116. In some embodiments, the final output layer may be a fully connected layer corresponding to a number of unique composition and concentration combinations that were used to train the model 112.

The composition identifier 113 may receive an unknown sample 114 and may use the model 112 to generate a prediction 116 for the unknown sample 114. In some embodiments, the composition identifier 113 may cause the deposit generator 105 to generate one or more deposits 104 of the unknown sample 114 using the same technique used to generate the deposits 104 from the known samples 103. After the one or more deposits 104 have dried, the composition identifier 113 may similarly cause the image generator 107 to generate an image 108 of each of the one or more deposits 104, and may cause the metric generator to generate a set of metrics 110 for each generated image 108.

Finaly, the composition identifier 113 may use the model 112 to generate a prediction 116 for each set of metrics 110 for the unknown sample 114. Depending on the embodiment, the composition identifier 113 may provide the generated predictions 116 (and associated confidence values) to the entity that provided the unknown sample 114. Note that in some embodiments, the images 108 of the unknown sample 114 may be used directly by the model 112, rather than a set of metrics 110.

In some embodiments, the composition identifier 113 may generate what is referred to as a consensus prediction of the unknown sample 114. In such embodiments, multiple deposits 114 of the unknown sample 114 may be generated, along with an image 108 (and optionally associated metrics 110 of each unknown sample 114). A prediction 116 is generated from each image 108 and/or metrics 108, and the generated predictions 116 may be combined to form a consensus prediction 116. For example, the predictions 116 may be averaged together to generate the consensus prediction 116.

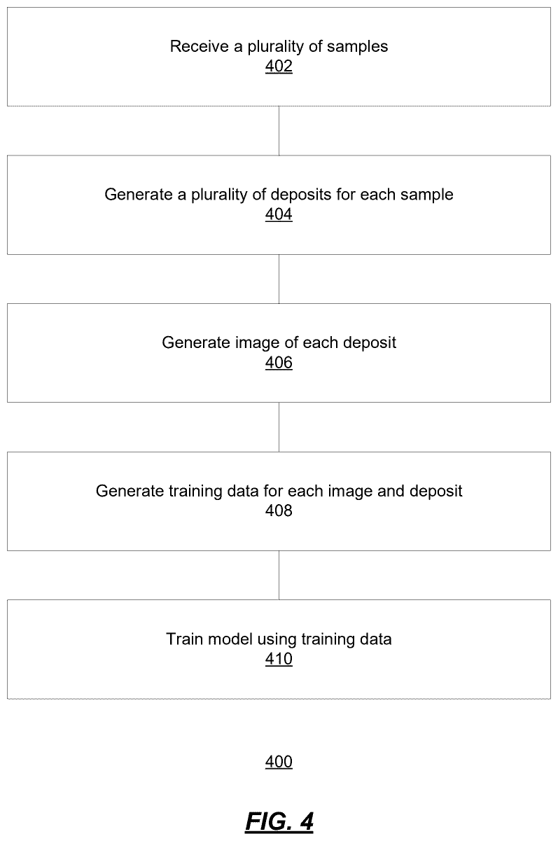

FIG. 4 is an illustration of an example method for training a model to identify compositions and concentrations from images of deposits. The method 400 may be implemented in part by the robotic drop imager system 100.

At 402, a plurality of samples is received. The plurality of samples may be received by the robotic drop imager system 100. Each sample may have a known sample and a known concentration.

At 404, a plurality of deposits is generated for each sample. The plurality of deposits may be generated by the deposit generator 105. In some embodiments, the deposit generator 105 may generate a plurality of deposits for each sample by using a pipette 209 and syringe pump 219 mounted to a two-dimensional positioning component. The two-dimensional positioning component may selectively move the pipette 209 to a position associated with a slide of the glass slides 211. The pipette 209 may then cause a single drop of a predetermined size to be deposited on the slide before it is moved to a location of a next slide.

At 406, an image of each deposit is generated. The image 108 of each deposit may be generated by the image generator 107. In some embodiments, the image generator 107 may generate the images using a camera 207 connected to the two-dimensional positioning component. A processing component of the system 100 may cause the two-dimensional positioning component to move the camera 207 overtop of each slide, and when the camera 207 is in position, the processing component of the system 100 may cause the camera 207 to capture and store an image 108 of the deposit 104 on the slide. Other methods may be used.

At 408, training data is generated for each image and deposit. In some embodiments, the metric generator 109 may generate the training data by associating (i.e., labeling) each image 108 with the known concentration and composition. Alternatively or additionally, the metric generator 109 may generate one or more metrics from the image 108. Some or all of the metrics are described in the above table, for example. More or fewer metrics may be used. The generated metrics and known concentration and composition of the deposit 104 depicted in each image 108 may be stored by the metric generator 109 as training data.

At 410, the model is trained using the training data. The model 112 may be trained by the model generator 111. In some embodiments, the model is a Multilayer Perceptron model. Other suitable models include a random forest model or an XGBoost model. Any method for training a model 112, may be used.

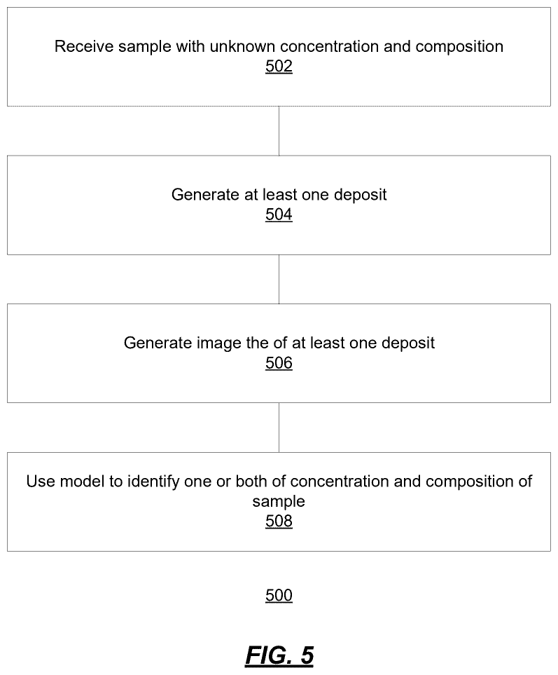

FIG. 5 is an illustration of an example method for training a model to identify compositions and concentrations from images of deposits. The method 500 may be implemented in part by the robotic drop imager system 100.

At 502, a sample with an unknown concentration and composition is received. The sample 114 may be received by the deposit generator 105 of the robotic drop imager system 100.

At 504, at least one deposit is generated for the sample. The at least one deposit may be generated by the deposit generator 105. The deposit generator 105 may use a two-dimensional positioning component to move a pipette 209 to a desired slide of a plurality of glass slides 211. The deposit generator 105 may then cause a deposit 104 to be dropped on the desired slide. Depending on the embodiment, multiple deposits 104 across several slides may be made.

At 506, an image of the at least one deposit is generated. The image 108 of the at least one deposit may be generated by the image generator 107. In some embodiments, the image generator 107 may generate the images using a camera 207 connected to the two-dimensional positioning component.

At 508, the model is used to predict one or both of the composition and the concentration. The prediction 116 may be generated by the composition identifier 113 using the model 112, and the image 108 of the deposit 104 formed from the unknown sample 114. In some embodiments, the metric generator 109 may first extract one or more metrics 110 from the image 108 of each deposit 104 made from the unknown sample 114.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by the device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communication connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here. Suitable computing devices 600 may include one or more smart phones or tablet computing devices with proprietary software or applications.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for determining composition and concentration of unknown samples, the method comprising:
receiving a plurality of samples by a computing device, wherein each sample has a known composition and known concentration;
for each sample of the plurality of samples, generating a plurality of deposits of the sample by the computing device;
for each deposit of the plurality of deposits, generating an image of the deposit by the computing device;
for each generated image of a deposit, labeling the image of the deposit with the known composition and known concentration of the deposit by the computing device; and
training a machine learning model with the generated images and associated labels by the computing device.

2. The method of claim 1, wherein the computing device is part of a robotic drop imager.

3. The method of claim 1, wherein each deposit has a controlled volume of between 1 and 50 μL.

4. The method of claim 1, further comprising waiting approximately 2 hours for the deposits to dry before generating the images.

5. The method of claim 1, further comprising, for each generated image of a deposit, generating a plurality of metrics from the image of the deposit, and associating the image of the deposit with the generated plurality of metrics.

6. The method of claim 5, wherein training a machine learning model with the generated images and associated labels comprises training the machine learning model with the plurality of metrics associated with each image and the labels associated with each image.

7. The method of claim 5, wherein generating the plurality of metrics from the image of the deposit comprises generating a binary image from the image, and generating the plurality of images from the binary image.

8. The method of claim 5, wherein the plurality of metrics comprise one or more of deposit area, boundary length, connected bright regions, and eccentricity.

9. The method of claim 8, the plurality of metrics further comprise a distribution of bright pixels from a centroid of the image.

10. The method of claim 9, wherein the plurality of metrics further comprise a mean, median, mode, standard deviation, and skewness of the distribution.

11. The method of claim 1, further comprising:
receiving a sample with an unknown composition and unknown concentration;
generate at least one deposit of the received sample;
generate an image of the at least one deposit; and
using the machine learning model to identify one or both of a composition and a concentration for the received sample.

12. A system for determining composition and concentration of unknown samples, the system comprising:
at least one computing device;
a deposit generator adapted to:
receive a plurality of samples, wherein each sample has a known composition and known concentration; and
for each sample of the plurality of samples, generate a plurality of deposits of the sample;
an image generator adapted to:
for each deposit of the plurality of deposits, generate an image of the deposit;
a metric generator adapted to:
for each generated image of a deposit, label the image of the deposit with the known composition and known concentration of the deposit; and
a training component adapted to:
train a machine learning model with the generated images and associated labels.

13. The system of claim 12, wherein the system is a robotic drop imager.

14. The system of claim 12, wherein each deposit has a controlled volume of between 1 and 50 μL.

15. The system of claim 12, wherein the image generator waits approximately 2 hours for the deposits to dry before generating the images.

16. The system of claim 12, wherein the metric generator is further adapted to, for each generated image of a deposit, generate a plurality of metrics from the image of the deposit, and associate the image of the deposit with the generated plurality of metrics.

17. The system of claim 16, wherein the model generator adapted to train the machine learning model with the generated images and associated labels comprises the model generator adapted to train the machine learning model with the plurality of metrics associated with each image and the labels associated with each image.

18. The system of claim 16, wherein the plurality of metrics comprise one or more of deposit area, boundary length, connected bright regions, and eccentricity.

19. The system of claim 16, the plurality of metrics further comprise a distribution of bright pixels from a centroid of the image.

20. The system of claim 12, wherein the system further comprises a composition identifier adapted to:
receive a sample with an unknown composition and unknown concentration;
generate at least one deposit of the received sample;
generate an image of the at least one deposit; and
use the machine learning model to identify one or both of a composition and a concentration for the received sample.
